(19) United States
(12) Patent Application Publication
(10) Pub. No.: US 2009/0061234 A1
(43) Pub. Date: Mar. 5, 2009

(54) Method for Inhibiting Corrosion of Metal in Distillation Units Caused by Organic Acids

(75) Inventors: Joseph L. Stark, Richmond, TX (US); Ksenija Babic, Katy, TX (US); Roger D. Metzler, Sugar Land, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: Baker Hughes Incorporated, Houston, TX (US)

(21) Appl. No.: 12/201,980

(22) Filed: Aug. 29, 2008

Related U.S. Application Data
(60) Provisional application No. 60/969,882, filed on Sep. 4, 2007.

(51) Int. Cl. B32B 9/00

(52) U.S. Cl. 428/411.1

(57) ABSTRACT

Corrosion may be inhibited in a separation unit by treating at least one surface of the separation unit with a corrosion inhibitor. The corrosion inhibitors are those having a general formula:

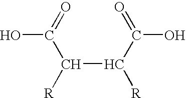

wherein each R is the same or different; each R is selected from the group consisting of: a hydrogen moiety, an alkyl moiety; an aromatic moiety and moieties having both an unsaturation and an aromatic group; and the sum of the number of carbons in the two R groups is from about 6 to about 30.

### CROSS REFERENCES TO RELATED APPLICATIONS

This application claims priority from the U.S. Provisional Patent Application having the Ser. No. 60/969,882 filed Sep. 4, 2007.

### BACKGROUND OF THE INVENTION

1. Field of the Invention

The invention relates to a method and composition useful for inhibiting corrosion of metal in contact with organic acids. This invention particularly relates to a method and composition useful for inhibiting corrosion of metal within distillation units that is in contact with organic acids.

2. Background of the Art

Organic acids can cause metal corrosion.

### SUMMARY OF THE INVENTION

In one aspect, the present invention is a method for inhibiting corrosion in a separation unit comprising treating at least one surface of the separation unit with a corrosion inhibitor, the corrosion inhibitor comprising a compound having a general formula:

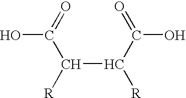

wherein each R is the same or different; each R is selected from the group consisting of: a hydrogen moiety, an alkyl moiety; an aromatic moiety and moieties having both an unsaturation and an aromatic group; and the sum of the number of carbons in the two R groups is from about 6 to about 30.

### BRIEF DESCRIPTION OF THE DRAWINGS

For a detailed understanding and better appreciation of the present invention, reference should be made to the following detailed description of the invention and the preferred embodiments, taken in conjunction with the accompanying drawings wherein:

FIG. 1 is a photo of the metal coupons used for Examples 1 and 2 after treatment;

FIG. 2 is a photo of the solution remaining after the testing in Example 1 and after the metal coupons are removed with the kettle on the left having been treated with Sample 2 and kettle on the right having been treated with Sample 1;

FIG. 3 is a photograph (10×) of a metal coupon surface prior to being tested in Example 6;

FIG. 4 is a photograph (10×) of a metal coupon surface after being tested in Example 6 using the method of the invention; and

FIG. 5 is a photograph (10×) of a metal coupon surface after being tested in Example 6 while not using the method of the invention (blank).

### DETAILED DESCRIPTION OF THE PREFERRED EMBODIMENT

In one embodiment, the invention is a method for inhibiting corrosion in a separation unit comprising treating at least one surface of the separation unit with a corrosion inhibitor, the corrosion inhibitor comprising a compound having a general formula:

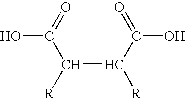

wherein each R is the same or different; each R is selected from the group consisting of: a hydrogen moiety, an alkyl moiety; and an aromatic moiety; and the sum of the number of carbons in the two R groups is from about 6 to about 30. Exemplary compounds useful with the present invention include those dicarboxylic acids within the scope of the general formula. For example, substituted succinate acids can be used where the sum of carbons in the substituted groups is from about 6 to about 30. Combinations of different dicarboxylic acids may also be used with the claimed method.

One dicarboxylic acid which can be used with an embodiment of the invention of the disclosure is dodecenyl succinic acid. Another compound useful with an embodiment of the invention is di-hexyl succinic acid. Similarly, the R groups of the general formula may include an unsaturation, an aromatic group or both an unsaturation and an aromatic group. In some embodiments, the dicarboxylic acids will be soluble in lower alkanes such as propane, butane, isobutene and pentane.

Referring to the general formula, in some embodiments, the R moieties may have a total of from about 8 to about 28 carbons. In other embodiments, the R moieties may have a total of from about 10 to 24 carbons. In still other embodiments the R moieties may have a total of from about 12 to about 18 carbons. Exemplary R groups, where R′ means a first R group and R″ means a second R group on the same molecule, may include but not be limited to:

| R′ | R″ |
|---|---|
| H | C₆ |
| H | C₁₂ |
| H | C₁₈ |
| H | C₂₂ |
| C₆ | C₆ |
| C₆ | C₁₂ |
| C₈ | C₁₂ |
| C₈ | C₁₈ |
| C₁₂ | C₁₂ |
| C₁₂ | C₁₈ |

The dicarboxylic acids useful with embodiments of the invention may be in either the acid or salt form or even half salt form when applied to the separation unit surfaces. They may be prepared by any method known to be useful to those of ordinary skill in the art. For example, in one embodiment, they may be isolated from naturally occurring sources. In another embodiment they may be synthesized directly from basic chemical. In one embodiment, they may be prepared by hydrolyzing an anhydride.

In an embodiment of the invention, the corrosion inhibitors are applied to the surface of a separation unit. Examples of separation units include, for example, distillation units, absorbers, extractors and combinations thereof. Distillation units achieve component separation based on the differences in boiling points of the species present in the process streams fed to the unit. Distillation units include, for example, distillation columns, fractionators, splitters, semi-continuous units, continuous units, flash units, batch distillation units, strippers, rectifiers, extractive distillation units, azeotropic distillation units, and vacuum distillation units and combinations thereof.

Absorbers and extractors are contacting units in which one or more fluid phases are contacted and desired component separation is achieved based on the affinity of components in one phase to either the components in the other phase or to suitably activated solid adsorbent materials packed in the unit. For example, a process stream containing components A and B may enter such a unit at one position while another process stream containing C may enter the unit at another position. One of these streams is typically liquid while the other can be liquid or vapor. Now assume component B has a much greater affinity for component C than for component A.

Intimately contacting of the two streams in a properly designed and operated contacting unit will result in creating one product stream containing component Awith a essentially no component B and a second product stream containing component C and essentially all of component B. Commercial use of such a unit might be driven by the difficulty of directly separating B from A versus of separating B from C. In this example the first product stream would be termed the desorbant and the second product stream would be termed the adsorbant. Specific examples of absorber units include continuous absorbers, temperature swing absorbers, pressure swing absorbers, purge/concentration swing absorbers and parametric pumping absorbers.

Extractors are contacting units in which immiscible liquid phases are contacted and component separation is achieved using a mass separating agent. In the example above, the component C in the second process stream would be the mass separating agent. An example of an extractor unit is an aromatics extraction unit wherein a hydrocarbon stream containing aromatic species and non-aromatic species are contacted with a mass separating agent such as sulfolane or morpholine and efficient contacting of these two immiscible liquids results in extraction of the aromatic species from the hydrocarbon steam into the stream containing the mass separating agent. Component separation units can also include a zone of catalytic materials to facilitate desired chemical reactions in the component separation unit. Examples of such include reactive distillation units and extractive distillation units.

The separation units of this application may also include compression units.

The corrosion inhibitors useful with embodiments of the invention can be used to treat structural components such as the walls of the separation units and piping joining sections of the separation units. The inhibitors may also be used to treat internal structures.

The separation units which may be treated include internal components such as trays, randomly packed rings or saddles, structured packing having meshes, monoliths, gauzes and the like, collectors, distributors, down corners, wall wipers, support grids and hold down plates. Any such internal structure that is subject to corrosion may be used with the invention.

The corrosion inhibitors that are embodiments of the invention are surprisingly effective at inhibiting corrosion by low molecular weight organic acids, carbonic acid, and hydrogen sulfide. Exemplary low molecular weight organic acids include formic acid, acetic acid, propionic acid, and the like, having a molecular weight of from about 40 to about 150 Daltons. Larger acids such as naphthenic typically break down to form such acids and carbon dioxide, making the corrosion inhibitors of the invention particularly useful in applications where they are found.

Further, these dicarboxylates are nitrogen free and also do not cause as much retention or transit of water as some nitrogen based corrosion inhibitors. Since the dicarboxylic acid corrosion inhibitors lack nitrogen, they may also be used in application where the presence of nitrogen can interfere in production by, for example, poisoning a catalyst or contaminating a product stream that would be thereby rendered off specification.

Since the production of gasoline and other finished fuels from crude oil almost invariably involves both hydrogen sulfide and naphthenic acids, in some embodiments, the method of the invention involves applying dicarboxylic acid corrosion inhibitors to the separation units in a refinery process. Some embodiments of the invention are particularly useful in applications where a production unit is processing crude oil that high in naphthenic acids.

While useful in refinery operations, certain embodiments of the invention are useful in petrochemical operations. One such application is the production of ethylene. Therein, there is a process to produce pyrolysis gasoline which includes a hydrogenation operation. This process is particularly susceptible to catalyst poisoning from amine and other nitrogen containing additives.

Use of the method of the invention may be useful in both refinery and petrochemical operation in that it allows for the operation of production separation units with less neutralizers for acids being added. In those applications where the neutralizers end up in recycle streams or knockout pots, they may cause undesirable results such as “salting” and foaming. By reducing the use of such neutralizers, operating may be continued for longer times with few unexpected interruptions of production.

The dicarboxylic acid components of embodiments of the method of the invention have another advantage of more conventional nitrogen containing corrosion inhibitors. This advantage is that the dicarboxylates are less sensitive to oxygen than most of the amines and other nitrogen containing compounds. While rarely desirable, an oxygen or air leak would have less negative impact on an application incorporating the dicarboxylates useful with embodiments of the present invention as compared to traditional amine based corrosion inhibitors such as, for example, imidazoline. This additive is effective under oxidative conditions where nitrogen based chemistry is generally less effective.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

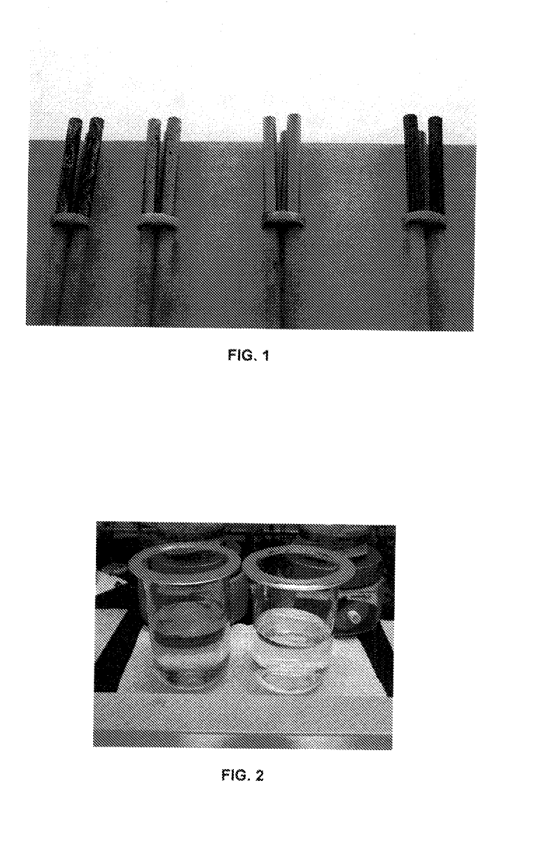

Kettle tests are run at 180° F. using two cylindrical carbon steel (C1018) and one Inconel 625 alloy coupons. The additive, Sample 1, is dodecenyl succinic acid. The coupons are bead-blasted to a uniform finish prior to testing. After the 24 h exposure period is over, the coupons are rinsed with solvent and bead-blasted to remove any deposit or scale. A control coupon was included with the test coupons to determine the amount of weight lost during the bead-blast procedure. The sample components and results are display in the Tables below. In the tables, CR is corrosion rate, IE is inhibitor efficiency. Exemplary Coupons after testing are shown in FIG. 1. Exemplary liquors from the tests are shown in FIG. 2.

### Comparative Example 2

Example 1 is reproduced substantially identically except that instead of dodecenyl succinate, a commercial imidazoline is used and is designated as Sample 2. The results are reported below in Tables 2 and 3.

TABLE 1

| | |
|---|---|
| Test temperature: | 180° F. (82.2° C. ± 0.2° C.) |
| Test duration: | 24 hours |
| Atmosphere: | N₂ sparge; or 1% H₂S, 2% CO₂ in N₂ |
| Stirring: | ~525 RPM |
| Test fluid: | DI water/Hydrocarbon solvent |
| Metallurgy: | Carbon steel (C1018), Inconel 625 |

TABLE 2

| | Solution component/ | Conc. | CR_{weight loss} | IE |
|---|---|---|---|---|
| Test fluid | metallurgy CS1018 | (ppm) | (mpy) | (%) |
| 0.1% CH₃COOH | Blank/ | — | 14.1 | — |
| (1% water)/ | Sample 1 | 10 | 0.1 | 99.3 |
| heptane (99 v %) | Sample 2* | 10 | 13.1 | 7.1 |
| Sparged with N₂ | | | | |

*Not an example of the invention

TABLE 3

| | Solution component/ | Conc. | CR_{weight loss} | IE |
|---|---|---|---|---|
| Test fluid | metallurgy CS1018 | (ppm) | (mpy) | (%) |
| 0.1% CH₃COOH | Blank | — | 8.7 | — |
| (1% water)/ | Sample 1 | 10 | 0.5 | 94.3 |
| heptane (99 v %) | Sample 2* | 10 | 8.4 | 3.4 |
| Sparged with N₂, | | | | |
| 1% H₂S, & | | | | |
| 2% CO₂ | | | | |

*Not an example of the invention

TABLE 4

| | Solution | | | |
|---|---|---|---|---|
| | component/ | | | |
| | metallurgy | Conc. | CR_{weight loss} | IE |
| Test fluid | CS1018 | (ppm) | (mpy) | (%) |
| 0.1% CH₃COOH + | Blank | — | 30.4 | — |
| 80 ppm HCl (5% water)/ | Sample 1 | 10 | 8.5 | 72.0 |
| heptane (95 v %) | Sample 1 | 20 | 2.9 | 90.5 |
| Water from overhead | Blank | — | 6.7 | — |
| stream from Crude | Sample 1 | 10 | 1.6 | 76.1 |
| Oil Refining (5 v %)/ | Sample 1 | 20 | no | 100 |
| heptane (95 v %) | | | corrosion | |
| Sparged with N₂, | | | | |
| 1% H₂S, & | | | | |
| 2% CO₂ | | | | |

TABLE 5

| | Solution | | | |
|---|---|---|---|---|
| | component/ | Conc. | CR_{weight loss} | IE |
| Test fluid | metallurgy | (ppm) | (mpy) | (%) |
| Water from overhead | Blank/CS1018 | — | 8.9 | — |
| stream from Crude | Sample 1 | 6 | 2.7 | 69.7 |
| Oil Refining (5 v %)/ | Sample 1 | 12 | 1.7 | 80.9 |
| Oil from overhead | Sample 1 | 18 | 1.2 | 86.5 |
| stream (95 v %) | Sample 1 | 20 | no | 100 |
| Sparged with N₂, | | | corrosion | |
| 1% H₂S, & | Blank/Inconel | — | 1.5 | — |
| 2% CO2 | 625 | | | |
| | Sample 1 | 6 | 1.3 | 13.3 |
| | Sample 1 | 12 | 0.9 | 40.0 |
| | Sample 1 | 18 | 0.6 | 60.0 |

### Example 3

Kettle tests are run as in Example 1, but in addition to a corrosion inhibitor of the invention, other compounds are included to determine if they will interfere with the corrosion inhibitor of the invention. The results are shown below in Tables 6-8.

TABLE 6

| | Solution | | | |
|---|---|---|---|---|
| | component/ | | | |
| | metallurgy | Conc. | CR_{weight loss} | IE |
| Test fluid | CS1018 | (ppm) | (mpy) | (%) |
| Water from overhead | Blank | — | 8.9 | — |
| stream from Crude | Sample 1/ | 20/200 | 0.2 | 97.8 |
| Oil Refining (5 v %)/ | water soluble | | | |
| Oil from overhead | corrosion | | | |
| stream (95 v %) Sparged | inhibitor | | | |
| with N₂, 1% H₂S, & | Blank | — | 6.7 | — |
| 2% CO2 | Sample 1/ | 20/200 | 0.0 | 100 |
| | water soluble | | | |
| | corrosion | | | |
| | inhibitor | | | |

TABLE 7

| | Solution | | | |
|---|---|---|---|---|
| | component/ | Conc. | CR_{weight loss} | IE |
| Test fluid | CS1018 | (ppm) | (mpy) | (%) |
| 0.1% CH₃COOH + | Blank | — | 30.4 | — |
| 80 ppm HCl | Sample 1 | 20 | no | 100 |
| (5% water)/ | | | corrosion | |
| heptane (95 v %) | Sample 1/water | 20/200 | 0.6 | 98.0 |
| | soluble amine | | | |
| | Sample 1/oil | 20/10 | 0.1 | 99.7 |
| | soluble amine | | | |

TABLE 8

| | Solution | | | |
|---|---|---|---|---|
| | component/ | Conc. | CR_{weight loss} | IE |
| Test fluid | Inconel 625 | (ppm) | (mpy) | (%) |
| 0.1% CH₃COOH + | Blank | — | 2.74 | — |
| 80 ppm HCl | Sample 1 | 20 | no | 100 |
| (5% water)/ | | oil phase | corrosion | |
| heptane (95 v %) | Sample 1/water | 20/200 | 0.2 | 92.7 |
| | soluble amine | | | |
| | Sample 1/oil | 20/10 | 0.2 | 92.7 |
| | soluble amine | | | |

### Example 4

Jet fuel is tested using the WSIM test as set forth in ASTM 3948. The blank has a WSIM number of 97. At 5 ppm Sample 1, the WSIM number is 93. At 10 ppm, Sample has a WSIM number of 89. At 15 ppm, the WSIM number is 91. This test shows that Sample 1 does not increase the moisture content of finished fuels to unacceptable levels.

### Example 5

Sample 1 was tested using the High Speed Autoclave Test. The water phase (5% volume) used to simulate condensate consisted of 100 ppm NaCl and 1 g/L sodium sulfate The remaining 95% of total volume was Isopar oil. The test was conducted in a rotating cage at 600 rpm. A water/oil admixture was sparged first with nitrogen and then with CO₂ gas at 60 psi. Carbon steel samples were exposed for 24 hours at 180° F. Sample 1 was used at 20 ppm. The corrosion rate obtained with untreated and treated solution shows that the blank corrosion rate is 176.52 mpy vs. 0.39 mpy in the presence of 20 ppm of Sample 1. This represents a 99.8% corrosion protection (or inhibitor efficiency) in presence of Sample 1.

### Example 6

The effect of the additive on the surface of carbon steel was determined by exposing steel coupons to corrosive conditions in the presence and absence of the claimed corrosion inhibitors. Experiments were performed in which the surfaces of carbon steel specimens were characterized visually and microscopically before and after exposure to a diesel/water mixture.

In this experiment, four cells containing a 90/10 diesel/Di water mixture were equipped with a magnetic stir bar, heating mantle, gas sparge tube, thermocouple, and water cooled condenser. Two cells were sparged with air (aerated), and two cells were sparged with nitrogen. All four cells were sparged for approximately 1 hour, while the temperature was equilibrating at the set point (100° F./37.8° C.).

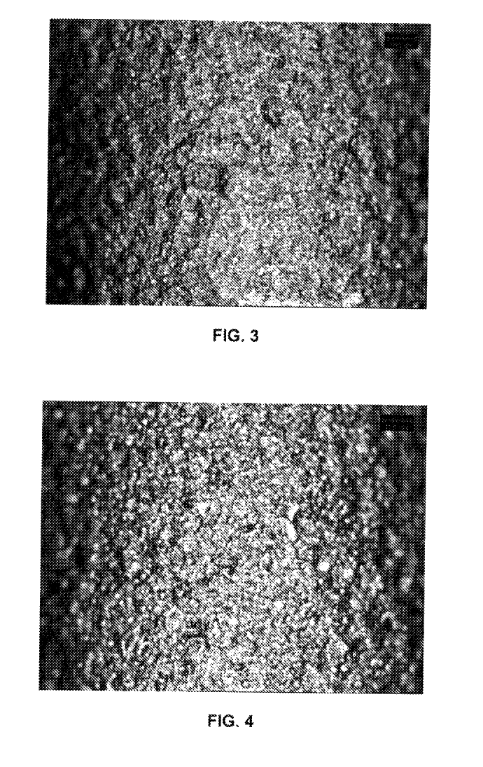

The coupons were bead-blasted prior to testing in order to provide a uniform surface finish, and to provide a roughened surface similar to what might be found in a pipe or tubing. An exemplary surface is shown in FIG. 3. A coupon that was exposed to an aerated blank is obviously corroded as there are large rust spots (3-5 mm diameter) and surface rusting covering approximately 70% of the coupon surface. After bead-blasting, the localized nature of the attack can be clearly seen. Most of the pits are around 0.25-0.35 mm in diameter and an exemplary surface is shown in FIG. 5.

The aerated mixture is the most aggressive of the conditions in this experiment. Extensive pitting was observed over most of the surface. The corrosion rate was approximately 7 mpy. Typically, cases of localized corrosion do not produce high general corrosion rates but penetration rates of the actual pits can be very high.

Although deaerated blank did have some surface modeling, it did not show any obvious signs of general or localized corrosion. A very small amount of rusting at the perimeter of the spots was observed by the time the images were recorded.

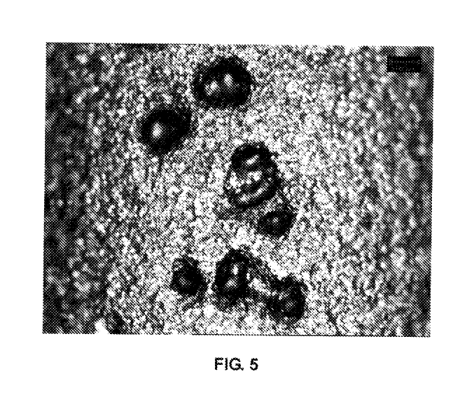

Both treated solutions (aerated+30 ppm Sample 1 and deaerated+30 ppm Sample 1, respectively) are similar in appearance and an exemplary surface is shown in FIG. 4. No signs of general or localized corrosion were observed for either of the coupons exposed to Sample 1.

Although general corrosion rates were low, the presence of oxygen encouraged pitting of carbon steel in the diesel/water mixtures. In fact, presence of Sample 1 inhibited general and localized corrosion in the most aggressive environment tested.

What is claimed is:

1. A method for inhibiting corrosion in a separation unit comprising treating at least one surface of the separation unit with a corrosion inhibitor, the corrosion inhibitor comprising a compound having a general formula: 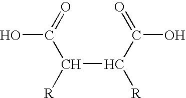
wherein:
each R is the same or different;
each R is selected from the group consisting of: a hydrogen moiety, an alkyl moiety; an aromatic moiety and moieties having both an unsaturation and an aromatic group; and
the sum of the number of carbons in the two R groups is from about 6 to about 30.

2. The method of claim 1 wherein the number of carbons in the two R groups is from about 8 to about 28.

3. The method of claim 2 wherein the number of carbons in the two R groups is from about 10 to about 24.

4. The method of claim 3 wherein the number of carbons in the two R groups is from about 12 to about 18.

5. The method of claim 1 wherein the corrosion inhibitor comprises a compound selected from the group consisting of dodecenyl succinic acid, di-hexyl succinic acid, and combinations thereof.

6. The method of claim 1 wherein the corrosion inhibitor comprises dodecenyl succinic acid.

7. The method of claim 1 wherein the corrosion inhibitor is prepared by hydrolyzing an anhydride.

8. The method of claim 1 wherein the separation unit is a distillation unit, an absorber, or an extractor.

9. The method of claim 8 wherein the separation unit is a distillation unit selected from the group consisting of distillation columns, fractionators, splitters, semi-continuous units, continuous units, flash units, batch distillation units, strippers, rectifiers, extractive distillation units, azeotropic distillation units, and vacuum distillation units.

10. The method of claim 8 wherein the separation unit is an absorber.

11. The method of claim 10 wherein the absorber is selected from the group consisting of include continuous absorbers, temperature swing absorbers, pressure swing absorbers, purge/concentration swing absorbers and parametric pumping absorbers.

12. The method of claim 8 wherein the separation unit is an extractor.

13. The method of claim 1 wherein the corrosion inhibitor is used to protect internal components of the separation units.

14. The method of claim 13 wherein the internal components are selected from the group consisting of: trays, randomly packed rings or saddles, structured packing having meshes, monoliths, gauzes and the like, collectors, distributors, down corners, wall wipers, support grids and hold down plates.

15. The method of claim 1 wherein the method is employed to prevent or mitigate corrosion caused by low molecular weight organic acids.

16. The method of claim 15 wherein the low molecular weight acids are selected from the group consisting of formic acid, acetic acid, propionic acid, and combinations thereof.

17. The method of claim 1 wherein the separation unit is part of a production facility for processing crude oil that is high in naphthenic acids.

18. The method of claim 1 wherein the production facility produces ethylene.

19. A method for inhibiting corrosion in a separation unit comprising treating at least one surface of the separation unit with a corrosion inhibitor a compound selected from the group consisting of dodecenyl succinic acid, di-hexyl succinic acid, and combinations thereof.

20. A method for refining crude oil comprising by inhibiting corrosion in a separation unit comprising treating at least one surface of the separation unit with a corrosion inhibitor, the corrosion inhibitor comprising a compound having a general formula: 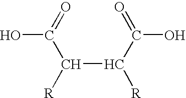
wherein:
each R is the same or different;
each R is selected from the group consisting of: a hydrogen moiety, an alkyl moiety; an aromatic moiety and moieties having both an unsaturation and an aromatic group; and
the sum of the number of carbons in the two R groups is from about 6 to about 30.
